(19) United States
(12) Patent Application Publication
(10) Pub. No.: US 2013/0304959 A1
(43) Pub. Date: Nov. 14, 2013

(54) Handheld Device Ecosystem with Docking Devices

(71) Applicant: PION TECHNOLOGIES INC., Alpharetta, GA (US)

(72) Inventor: Ryan P. Chiang, Alpharetta, GA (US)

(21) Appl. No.: 13/889,699

(22) Filed: May 8, 2013

Related U.S. Application Data
(60) Provisional application No. 61/645,611, filed on May 10, 2012.

(51) Int. Cl. G06F 1/16

(52) U.S. Cl. CPC G06F 1/1632
USPC 710/303

(57) ABSTRACT

A handheld device that can be reconfigured according to environment data. The handheld device can connect to different docking stations and the handheld device may be reconfigured differently for each docking station. When the handheld device connects to a docking station, the handheld device receives a set of parameters (environment data) and the handheld device uses this set of parameters to reconfigure itself. The reconfiguration includes selecting an application based on the set of parameters and launching the selected application.

### RELATED APPLICATION

This application claims the benefits of U.S. Provisional Application 61/645,611, filed on May 10, 2012 and currently pending, the specifications of which is included in its entirety by this reference.

### FIELD OF THE INVENTION

The present invention generally relates to mobile computing device and more specifically to multiple purpose auto reconfigurable mobile computing device.

### BACKGROUND OF THE INVENTION

Technological proliferation of consumer electronic devices has given rise to a host of household electronics in the average Western home. Devices such as the electronic alarm clock, the mobile music player, and the cellular phone are nearly ubiquitous in modern life, while digital photo frames, televisions, battery chargers, and digital cameras have also proliferated in the domestic environment.

The rapid pace of technological advancement combined with the sheer variety of usable items and their mutually divergent uses has led to a lack of cross communication capability between the various devices themselves. The user must remember and be able to interface with a wide variety of devices which may have little in common by way of user interaction; for example, although a microwave, a television remote control, and an electronic phone may all have keypads in common, the microwave keypad is used to specify cooking duration and intensity, the television remote is used to adjust channel and other display functionality, and the phone keypad is used to dial strings of numbers serving as an electronic address to access a matching phone. This multiplies the user burden for operating the various electronic devices in the household, and is especially exacerbated when the user must interact with a device which may operate for long periods of activity without any user input (e.g. smoke alarms). The user may long have discarded any operating manuals. Furthermore, many devices must be adjusted by hand whenever a change in operation is desired; for example, clocks which are not synchronized to an external time source often require semiannual recalibration to account for Daylight Savings Time. Lastly, some devices require security authentication in the form of passwords or other validation measures to access their features, increasing the logistical burden on the user even more.

The aforementioned disadvantages identify the problems associated with proliferation of highly specialized tools and the associated multiplication of required basic competency to operate the devices. Conventional wisdom has been to make device operation as user-friendly and accident-proof as possible, but “as possible” implies certain limits of complexity beyond which it is not possible to further simplify. It is therefore an aim of the present invention to simplify the operation of various electronic devices, store user preferences for convenient state recall, and lessen the burden of device usage on the consumer.

### SUMMARY OF THE INVENTION

In one embodiment, the present invention provides a method for reconfiguring a mobile device. The method comprises connecting the mobile device to a docking station, receiving, at the mobile device, a plurality of environment parameters, selecting an application from a plurality of applications stored in a storage unit on the mobile device according to the plurality of environment parameters, and executing a selected application by the mobile station.

In an alternative embodiment, the present invention also provides a reconfigurable mobile device for connecting to a plurality of docking stations. The mobile device comprises docking interface unit for connecting to a docking station, a storage unit for storing a plurality of applications, an external interface unit for controlling a plurality of equipments attached to the mobile device, and a central processing unit (CPU), wherein the docking interface receives a plurality of parameters, the CPU selects and executes an application from the plurality of applications based on the plurality of parameters, and the mobile device is reconfigured according to a selected application.

In yet another alternative embodiment, the present invention provides a system for reconfiguring a handheld device for different functionalities. The system comprises a handheld device having a storage unit for storing a plurality of applications and a docking interface unit and at least one docking station for connecting to the handheld device. The handheld device connects to a docking station, receives environment data, selects an application from the storage unit according to the environment data, and reconfigures using the environment data and the selected application.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view 100 of employment of a handheld device of the invention;

FIG. 2 illustrates a block diagram 200 of a handheld device of the present invention;

FIG. 3 illustrates a block diagram 300 of a docking station of the present invention;

FIG. 4 is a flowchart 400 for auto reconfiguration of the handheld device according to the present invention;

FIG. 5 is a flowchart 500 for environment detection and application launching according to the present invention; and

FIG. 6 is a flowchart 600 for environment detection and application launching according to another embodiment the present invention.

### DETAILED DESCRIPTION OF THE PREFERRED EMBODIMENTS

The present invention comprises an ecosystem that consists of a handheld computing device and various docking devices that extend the functionality of the handheld device. The handheld device, when “connecting” to one of the docking devices, identifies the docking device, detects the capabilities of the docking device, and reconfigures itself by running an a specialized application with a set of parameters for the docking device and for the environment that the docking device is in. The handheld device may download and install the applications that have not been previously installed. When the handheld device is docked to the docking device, the handheld device may authenticate the docking device first then launches a software application or a set of software applications that matches the capabilities of the docking device and the application selection criteria based on user settings as well as the parameters and/or other selected data from the docking device. The handheld device and mobile device are used interchangeably in this specification.

The “connecting” process and the “docking” process may be two independent processes. The handheld computing device may be “connected” with the docking device via a wired or wireless connection, or directly via the docking interface.

The handheld device of the present invention reconfigures automatically after being connected or docked to a docking station and launches a specially configured application or a set of specially configured applications. The specially configured application is selected based upon a set of parameters. The set of parameters may be docking station specific, such as device identity, device capabilities, device preferences, and device data. The set of parameters may also be user dependent, such as user preferences, or environment dependent, such as temperature or other environment indicators.

The docking device extends the handheld device's capabilities and also provides environment data to the handheld device. For example, the docking device may be equipped with sensors, such as temperature sensor and humidity sensor and the handheld device may use the environment data (temperature and humidity) to control a central air conditioning system. The docking device may also be equipped with high quality speakers and a larger display screen and the handheld device may use the docking device for remote monitoring.

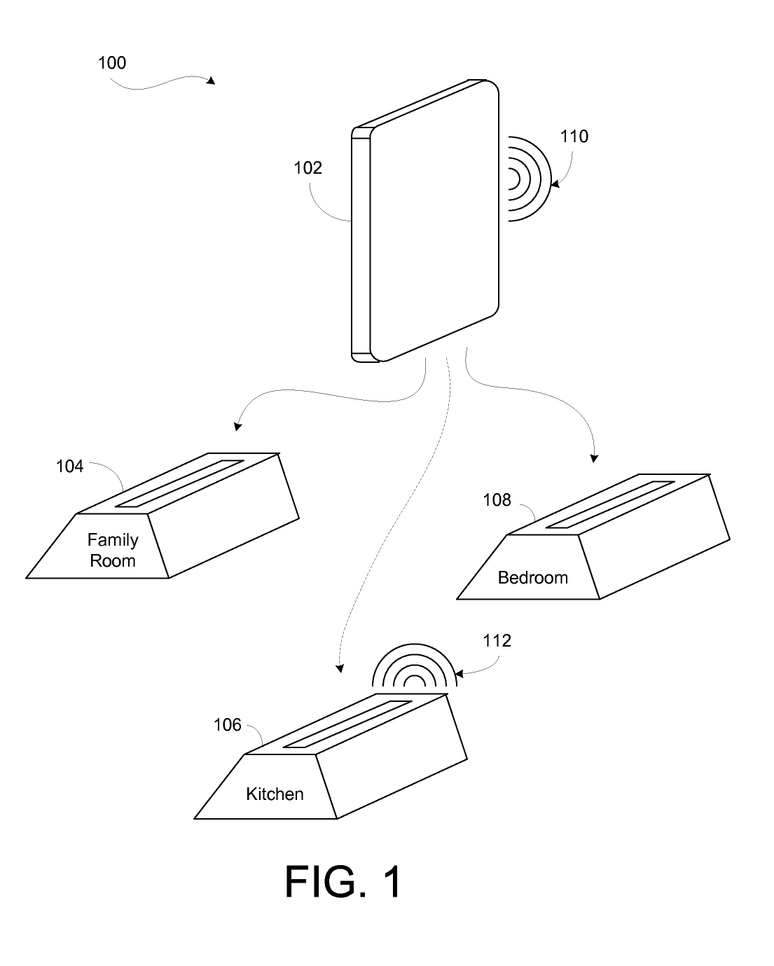

FIG. 1 shows a schematic view 100 of employment of the present invention. A handheld device (mobile device) 102 can be connected or docked to different docking devices 104, 106, 108. The docking can be physical by inserting the handheld device 102 into a docking device, such as docking device 104 or 108. The handheld device 102 can also be connected to a docking device 106 via wireless communication, such as WiFi 110 and 112. The docking devices can be placed in different rooms through a house and the handheld device 102 will configure itself for a particular application suited for the docking station to which the handheld device 102 is docked or connected.

The handheld device 102 and docking devices 104, 106, 108 implement a mechanical locking mechanism and an electronic connection interface to physically connect the handheld device 102 to the docking device. The handheld device 102 and docking devices 104, 106, 108 implement a protocol for the handheld device 102 to detect the identifier and capabilities of each docking device and for each docking device to communicate its device preferences, configuration parameters, state variables and other data with the handheld device 102 when connection occurs. A standard based protocol for the handheld device 102 and the docking devices may be used to perform authentication and key exchange when docking occurs.

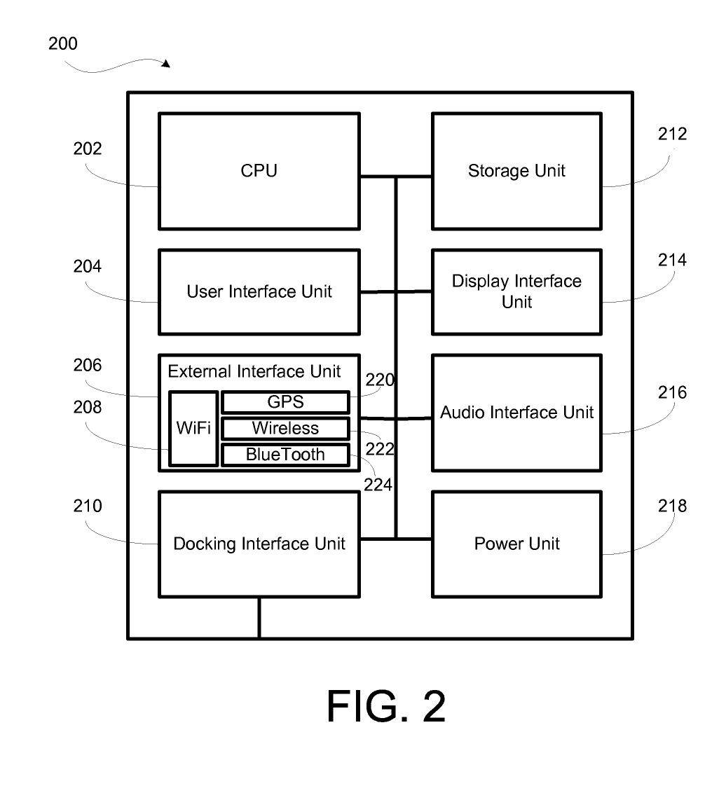

FIG. 2 illustrates a block diagram 200 of a handheld device 102 of the present invention. The handheld device 102 has a central processing unit (CPU) 202, a user interface unit 204, an external interface unit 206, a docking interface unit 210, a storage unit 212, a display interface unit 214, an audio interface unit 216, and a power unit 218. The CPU 202 executes instructions and applications that may reconfigure the handheld device 102 according to information received from either the docking device or taken from the environment. The user interface unit 204 controls interface with the user. The external interface unit 206 controls WiFi device 208, global positioning system (GPS) device 220, wireless device 222, and Blue Tooth device 224. The docking interface unit 210 controls interface with the docking device. The storage unit 212 may store different applications used for different docking stations. The display interface unit 214 controls a display unit (not shown) that may be on the handheld device 102 or may also be an external display device. The audio interface unit 216 controls audio speakers (not shown) that may be on the handheld device 102 or may be external to the handheld device 102. The power unit 218 controls the battery and the power delivery to the handheld device 102. It is understood by those skilled in the art that components shown in FIG. 2 are for illustration purpose only and functions performed by multiple components may be combined and performed by a single component.

The handheld device 102 receives launch conditions either from the docking station 104 (docking station 104 used as example for simplicity of description) that it is connected to or by capturing from the environment that it is in. Examples of capturing from the environment include taking the temperature of the environment, taking a picture of the environment, and obtaining the GPS coordinates. The capturing of information from the environment may be done by either equipment attached to the docking station 104 or equipment attached to the handheld device 102. The handheld device 102 implements an algorithm that constructs an application launch table that matches the launch conditions. For each docking station 104 that the handheld device 102 is docked or connected, there is an application launch table stored in the storage unit 212. Each launch table includes a plurality of applications and their respective launch conditions. The launch conditions are used to prioritize and to select the applications for launch. The application launch table may be periodically updated based on the latest information or specific data for the docking station 104; the information and specific data include, but not limited to, the application usage/launch frequency, the application status, and the device status or the preference from the docking device vendors. The application defined in this context is a software implementation that executes desired logics, communicates with (a) network server(s), and interacts with the user via the user interface unit 204 to enable certain user sensible features. The application is also downloadable from a network server.

The handheld device 102 may pre-download and install the applications based on the preferred applications defined in the application launch table if the application has not been previously installed. A docking station 104 may support different applications and the handheld device 102 may download and install a lower priority application if higher priority applications cannot be reached or downloaded.

The handheld device 102 may implement a user interface that creates and displays a user interface page or a user interface container aggregating the latest preferred applications when docking to a docking device. The handheld device 102 may also implement a user interface to allow the user to choose one of the high-priority preferred applications or overwrite the top-priority preferred application.

When docking occurs, the handheld device 102 memorizes the running application and its state variables by storing them in the storage unit 212 and acquires the latest state variables from the docking device. The handheld device 102 then launches the application that matches the launching conditions that may take into account the latest status of the handheld device 102 or the docking device. During the time the handheld device 102 is connected with the docking station 104, the handheld device 102 can control the devices and equipments on the docking station 104. When the handheld device 102 is removed from the docking device, the handheld device 102 may close the launched application, retrieves the stored information from the storage unit 212, and resume the application that runs before the docking occurs.

The handheld device 102 may charge the battery with power from the docking station 104 or directly from a power outlet.

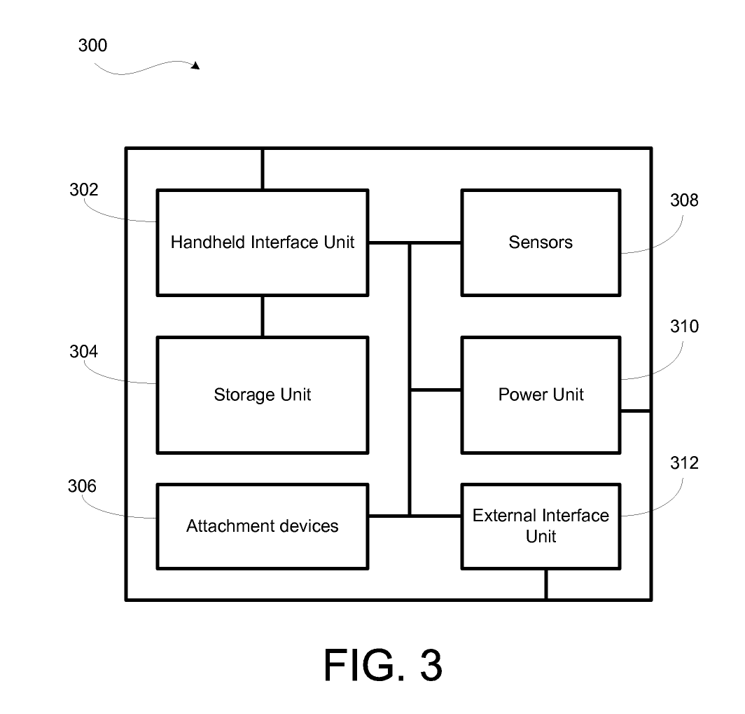

FIG. 3 illustrates a block diagram for a docking station 104. The docking station 104 may include a handheld interface unit 302, a storage unit 304, sensors 308, a power unite 310, attachment devices 306, and an external interface unit 312. The sensors 308 capture environment information, such as temperature, humidity, motions, etc. The attachment devices 306 may include speakers, display screen, projector, etc. The external interface unit 312 may interface with coaxial cable, fiber optic cable, radio signals from service providers, etc. The handheld interface unit 302 interfaces with the handheld device 102 either through direct connection when the handheld device 102 is docked or through wireless transmission when the handheld device 102 is connected wirelessly to the docking station 104. The storage unit 304 may include docking station information, which includes model, maker, software version, website information (where to download updated software), etc. The storage unit 304 may also include applications for controlling attached devices. The power unit 310 may be a simple connection to a power outlet and may also include a battery for providing power to different sensors 308 and attached devices 306.

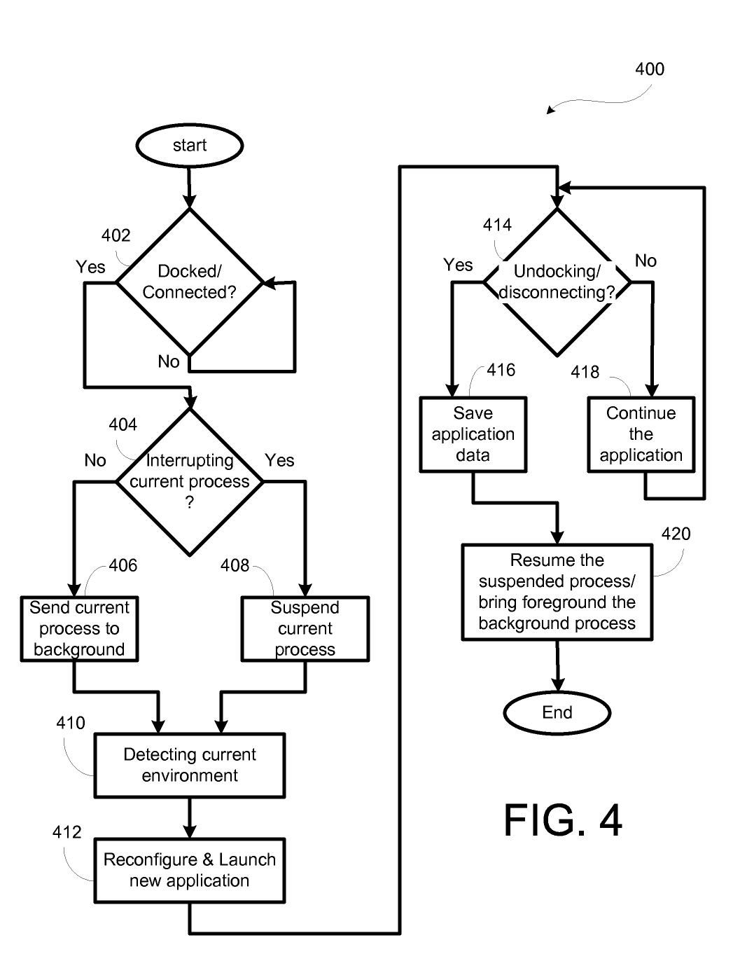

FIG. 4 is a flowchart 400 illustrating connection and auto reconfiguration of a handheld device 102. The handheld device 102 checks whether it has been docked or connected to a docking station 104, step 402. The connection between the handheld device 102 and the docking station 104 can be done through physically docking the handheld device 102 into the docking station 104 or connecting wirelessly the handheld device 102 with the docking station 104. If the handheld device 102 is not docked, the handheld device 102 continues with the application it is performing. If the handheld device 102 detects that it has been docked to a docking station 104, the handheld device 102 checks if it needs to interrupt the process or application that it is running, step 404. If the current process the handheld device 102 is running is incompatible with the process or application for the docking station 104, the current process is suspended, step 408, and the state information for the current process is stored in the storage unit 212. If there is no need to suspend the current process, the current process is “sent” to background processing, step 406.

After disposing the current process, the handheld device 102 detects the current environment, step 410. The current environment can be detected by retrieving information from the storage unit 304 in the docking station 104. The information may also be retrieved from the handheld device 102. The retrieved information may include the docking location, whether the docking station 104 is in a bedroom, a family room, an office, or some other place. The retrieved information may also include the condition of the environment, such as room temperature, GPS coordinates, and the local time, and devices attached to the docking station 104. After learning where the docking station is located, the condition of the location, and the hardware devices attached to the docking station, the handheld device 102 can determine which application is suitable for this docking station under the current condition. The handheld device 102 can then reconfigure itself by loading appropriate variables and launch the selected application, step 412. While the handheld device 102 is connected to the docking station 104, the handheld device 102 can receive inputs from users and control the equipments attached to the docking station 104 according to the received inputs.

The handheld device 102 will also check whether it is being disconnected or undocked from the docking station 104, step 414. While the handheld device 102 is not being undocked, the handheld device 102 continues to run the application, step 418. If the handheld device 102 senses it is being disconnected or undocked from the docking station 104, the handheld device 102 save the application data on the storage unit 212. The application data may also be saved on the storage unit 304 on the docking station 104. After being undocked from the docking station 104, the handheld device 102 resumes the suspended process or brings to the foreground the background process, step 420.

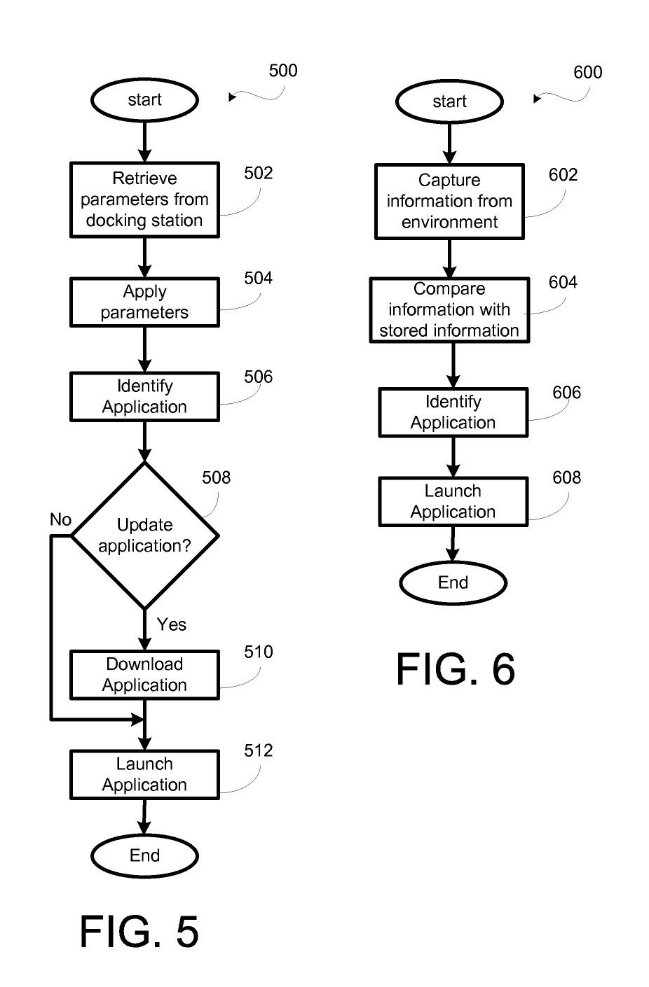

FIG. 5 is a flowchart 500 illustrating environment detection and application launching process. After being docked or connected to the docking station 104, the handheld device 102 retrieves a set of parameters from the docking station, step 502. The set of parameters (or retrieved information) identifies the environment condition to the handheld device 102. The handheld device 102 loads the parameters into proper registers in the handheld device 102, step 504. The handheld device 102 also identifies the application, step 506, based on the set of parameters and checks if the pre-loaded application needs to be updated, step 508. If the pre-loaded application is outdated, the handheld device 102 updates the application, step 510, by downloading a newer version from a server or through a website. The docking device 104 may store the website information on the storage unit 304. After the application is identified and updated, if necessary, the handheld device 102 launches the application, step 512.

Alternatively the handheld device 102 may also identify the environment by using the information stored and/or captured from the environment as process 600 of FIG. 6 illustrates. The environment may be identified through the information captured from the environment. The handheld device 102 captures the information from the environment, step 602, and compares the captured information with stored information, step 604. After the comparing the captured information with the stored information, the handheld device 102 identifies the application, step 606, and launches the application, step 608. If the captured information is not enough to identify the environment, the handheld device 102 may also used additional information retrieved from the docking station to help identified the environment.

The following is an example of identifying the environment by capturing the information from the environment. Assume that the handheld device 102 may be docked to a docking station 104 in the family room or to a docking station 108 in a bedroom. If the handheld device 102 is docked to the docking station 104 in the family room, the handheld device 102 will reconfigure itself as a media player or a set-top box that allows the user to control video display to a TV connected to the docking station 104. If the handheld device 102 is docked to the docking station 108 in the bedroom, the handheld device 102 will reconfigure itself as a radio with an alarm clock. The handheld device 102 includes a camera and also stores one set of photos of the family room and one set of photos of the bedroom, each set taken when the handheld device 102 is first docked to the respective docking station. When the handheld device 102 is docked to a docking station, the handheld device 102 detects the docking and then automatically takes a photo of the environment. After taking the photo, the handheld device 102 compares the photo with both sets of photos. The handheld device 102 will detect one photo from one set of photos that most resembles the photo just taken and then identifies the location to which it is in. It is recommended a set of photos to be stored for each docking station because the docking station may be moved or rotated inadvertently.

The handheld device 102 of the present invention can be reconfigured into different appliances. The following are descriptions of various appliances that the handheld device 102 can be reconfigured to.

### TV Dock

The handheld device 102 may connect to a docking station 104 connected to a TV via one of the standard video connectors, for instance, HDMI, DVI, Component or Composite. In addition, the docking device 104 may support features including, but not limited to, infrared (IR) receiver, channel/volume up/down buttons, battery charger, and video output.

Suppose that the handheld device 102 is capable of accessing and decoding channel contents from a service provider. When the handheld device 102 docks, the handheld device 102 detects the docking device 104 and reconfigures as a TV Dock that supports the IR receiver and/or channel/volume up/down buttons. The handheld device 102 launches a preferred application that may emulate a set-top box front panel. In this case, the handheld device 102 and the docking station 104 are converted to a “set-top box” like device without user's interaction with the handheld device 102 to launch the application.

Depending on the user setting, the handheld device 102 may display a few preferred applications for user to choose when the handheld device 102 is first docked to the docking device 104. The user may set the user preference for a different TV application that may cycle family photos stored on the handheld device and feed the video signal in parallel to the connected TV. The user may start watching video directly on the handheld device 102 then decides to watch on a TV by docking the handheld device 102 to the docking station 104. In this case, the video will be displayed on the TV and the handheld device 102 may start acting as a digital photo frame.

In other application scenarios, the handheld device 102 may act as an information board that cycles the information from a web service that the user has previously selected while outputting video and receiving the signal from the user's remote controller.

When the handheld device 102 is undocked, the launched application triggered by docking will be closed and the previously running application will be resumed.

### Bedside Dock

The handheld device may connect to a docking station 104 is placed in a bedroom environment. The docking station 104 may support features including, but not limited to, speaker/amplifier, radio, and battery charger.

When the handheld device 102 docks, the handheld device 102 detects the docking station 104, reconfigures itself as a Bedside Dock, and launches a preferred application that may emulate an alarm/radio clock. The alarm may set off, based on the user setting, one of the following: TV on a preset channel, radio from a present station from the Internet or air, audible news feed service from the Internet (Internet radio), music selected from the storage unit from the handheld device 102, and custom alarm sound. The handheld device 102 uses the infrared signal, on the handheld device 102 or on the docking station 104, to communicate with the TV.

The preferred application may turn off the WiFi connection based on the pre-configured time window (for example, sleep hours) in this docking mode and turn on the WiFi connection when the screen is touched or the time window expires.

### Photo Frame Dock

The handheld device 102 may connect to a docking station 104 and executes an application to emulate a digital photo frame. The docking station 104 may support features including, but not limited to, industrial design of photo frame, wall mount or easel back, memory card slot such as xD/SD or USB, motion sensor, high resolution camera, and battery charger.

When the handheld device 102 docks with a docking station 104 and detects the docking station 104 is a photo frame dock, the handheld device 102 launches a preferred application that cycles the photos stored in a specified location that may be located on a xD/SD memory card, a storage unit on the docking station 104, or a directory on a network storage.

The application may cycle the photos along with information from pre-configured sources including, but not limited to, local weather, schedule reminder, traffic report, local commercial promotions (filters set by the user), and emergency alert. The application may turn off the screen when the motion sensor detects no motion for a pre-configured period of time.

In this docking mode, the handheld device 102 may also pre-install and/or launch applications including, but not limiting to, intercom application for in-home communication, voice over Internet Protocol (VoIP) or Video phone application for calling outside of the house, and TV application.

The handheld device 102 may also use the high-resolution camera on the docking station 104 to take a photo of the environment and use an image recognition application to compare with images pre-stored on the memory card (the device data) to identify the location or environment and launch an application accordingly. For instance, the handheld device 102 may launch a TV application if the environment is kitchen and motion sensor detects motion during a pre-configured time window.

### Security Dock

The handheld device 102 may connect to a docking station 104 acting as a security dock, which may support features including, but not limited to, high definition (HD) camera with swivel control, wired network port, battery bay to extend the operation hours during power outage, high quality motion sensor, /easy disguisable industrial design, other sensors (temperature, CO,CO₂, smoke), and extension port to other security devices or sensors.

When the handheld device 102 docks and detects the docking station 104 acting as a security dock, the handheld device 102 launches a preferred security application that may establish a connection through the Internet with a remote security server and perform surveillance on the local area. The security application may also periodically communicate with the user's mobile device via the security server on the surveillance status.

### Automobile Dock

The handheld device 102 may connect to a docking station 104 acting as an automobile dock, which may support features including, but not limited to, Global Positioning System (GPS), 3G/4G connection, audio output to automobile speakers, noise cancelling microphone, and mechanical mount system for automobile.

When the handheld device 102 docks and detects the docking station 104 as an automobile dock, the handheld device 104 launches a preferred navigation application and applications that may connect to the Internet to provide travel information such as restaurant, tourist guide and etc.

### Outdock Dock

The handheld device 102 may connect to a docking station 104 that acts as an outdoor dock that supports features including, but not limited to, rugged industrial design for outdoor use, Global Positioning System (GPS), radio station, 3G/4G connection, satellite connection, and extended battery bay that may accommodate normal batteries such as AA/AAA.

When the handheld device 102 docks and detects the docking station 104 acting as an Outdoor Dock, the handheld device 102 launches a preferred application that download a map with extensive local details. The handheld device 102 may download and install the other applications such as first aid procedure, survival guide that are related to outdoor activities.

### Commerce Dock

The handheld device 102 may connect to a docking station 104 that acts as a commerce dock and supports features including, but not limited to, credit card swipe and bar code scanner.

When the handheld device 102 docks and detects the docking station 104 acting as a commerce dock, the handheld device 102 may launch a preferred application that displays a cashier interface for checking out customers.

### Keyboard Dock

The handheld device 102 may connect to a docking device 104 that acts as a keyboard dock and supports features including, but not limited to, keyboard and mouse device.

When the handheld device 102 docks and detects the docking device 104 acting as a keyboard dock, the handheld device 102 may launch an email application, a calendar application or a search engine that requires input from keyboard.

### Phone Dock

The handheld device 102 may connect to a docking station 104 acting as a phone dock that supports features including, but not limited to, telephone handset, speaker phone, and battery charger.

When the handheld device 102 docks and detects the docking station 104 acting as a phone dock, the handheld device 102 may launch a phone application where selection of a phone entry or a phone service ID (such as a Skype™ ID) will invoke a call that establishes a connection via the corresponding medium (phone line or VoIP) or corresponding phone service provider. The application may also be able to switch between handset and speaker.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims. It is understood that features shown in different figures can be easily combined within the scope of the invention.

What is claimed is:

1. A method, for reconfiguring a mobile device, comprising the steps of:
connecting the mobile device to a docking station;
receiving, at the mobile device, a plurality of environment parameters;
selecting an application from a plurality of applications stored in a storage unit on the mobile device according to the plurality of environment parameters; and
executing a selected application by the mobile station.

2. The method of claim 1 further comprising the steps of:
interrupting a previously executing application before executing the selected application; and
resuming the previously executing application after the mobile device being disconnected from the docking station.

3. The method of claim 1 further comprising the steps of:
disconnecting the mobile device from the docking station; and
storing application data related to the selected application in the storage unit.

4. The method of claim 1 further comprising the steps of:
checking whether there is a new version of the selected application; and
downloading to the mobile device the new version of the selected application from a remote server if there is a new version of the selected application.

5. The method of claim 1, wherein the plurality of environment parameters are captured by the mobile device.

6. The method of claim 5, wherein the plurality of environment parameters comprise a plurality of photos and the step of selecting an application from a plurality of applications stored in a storage unit on the mobile phone according to the plurality of environment parameters further comprises the steps of:
capturing a photo by the mobile device after the mobile device being connected to the docking station; and
selecting the application based on comparison of the photo with the plurality of photos.

7. The method of claim 1, wherein the plurality of environment parameters are retrieved from the docking station.

8. The method of claim 1, wherein the step of connecting the mobile device to a docking station is done by physically docking the mobile device into the docking station.

9. The method of claim 1, wherein the step of connecting the mobile device to a docking station is done by connecting wirelessly the docking the mobile device with the docking station.

10. The method of claim 1, further comprising the steps of:
receiving, at the mobile device, user inputs; and
controlling equipments attached to the docking station according to the user inputs.

11. A reconfigurable mobile device, for connecting to a plurality of docking stations, comprising:
docking interface unit for connecting to a docking station;
a storage unit for storing a plurality of applications;
an external interface unit for controlling a plurality of equipments attached to the mobile device; and
a central processing unit (CPU),
wherein the docking interface receives a plurality of parameters,
the CPU selects and executes an application from the plurality of applications based on the plurality of parameters, and
the mobile device is reconfigured according to a selected application.

12. The reconfigurable mobile device of claim 11, wherein the CPU interrupts a previously executing application before executing the selected application and resumes the previously executing application after the mobile device being disconnected from the docking station.

13. The reconfigurable mobile device of claim 11, wherein the storage unit further stores application data related to the selected application.

14. The reconfigurable mobile device of claim 11, wherein the plurality of parameters are received from the external interface unit.

15. The reconfigurable mobile device of claim 14, further comprising a camera connected to the external interface unit, and wherein the plurality of parameters comprise a plurality of photos and the camera captures a photo after the mobile device being connected to the docking station and the CPU selects the application based on comparison of the photo with the plurality of photos.

16. The method of claim 11, further comprising a WiFi for connecting the mobile device to the docking station.

17. The method of claim 11, further comprising a user interface unit for receiving user inputs, wherein the CPU controls equipments attached to the docking station according to the user inputs.

18. A system, for reconfiguring a handheld device for different functionalities, comprising:
a handheld device having a storage unit for storing a plurality of applications and a docking interface unit; and
at least one docking station for connecting to the handheld device,
wherein
the handheld device connects to a docking station, receives environment data, selects an application from the storage unit according to the environment data, and reconfigures using the environment data and the selected application.

19. The system of claim 18, wherein the handheld device receives the environment data from the docking station and the handheld device controls equipments attached to the at least one docking station.

20. The system of claim 18, wherein the handheld device receives environment data from an equipment on the handheld device.
